(19) United States
(12) Patent Application Publication
(10) Pub. No.: US 2006/0215728 A1
(43) Pub. Date: Sep. 28, 2006

(54) Forehead thermometer for hygienic measurement

(76) Inventor: Chen-Chang Jang, Lu-Chou (TW)

Correspondence Address: Chen-Chang Jang, P.O. Box 55-846, Taipei, 104, TW

(21) Appl. No.: 11/089,924

(22) Filed: Mar. 28, 2005

(51) Int. Cl. G01J 5/00

(52) U.S. Cl. 374/121

(57) ABSTRACT

A forehead thermometer includes: a main body having a probe formed on a front portion of the main body, a thermal-mass sleeve concentrically formed in a central hole of the probe, a Fresnel lens formed on a front end portion of the probe for focusing an incoming infrared temperature signal as emitted from the temperature sensing area on a patient's forehead to an infrared sensor secured to a bottom portion of the sleeve, an electronic circuit connected with the sensor and secured in the main body, and a lamp connected to the circuit and formed in the main body juxtapositioned to the sensor for projecting light forwardly to be parallel to a longitudinal axis of the Fresnel lens and the sensor for optically aiming a reference target area approximating the temperature sensing area for quickly locating the temperature sensing area for hygienically measuring a patient's body temperature.

### BACKGROUND OF THE INVENTION

In late 2002, a virus called Severe Acute Respiratory Syndrome (SARS) virus was suspected to be derived from China and then spread worldwide. For checking whether someone is infected by the SARS virus, a simple method is used to measure his or her forehead temperature. Once an abnormal high temperature is sensed, the patient is then recommended to be isolated to prevent from the spreading of such a terrible virus.

U.S. Pat. No. 6,292,685 entitled “Temporal Artery Temperature Detector” to Francesco Pompei seems to be a convenient thermometer for checking one's forehead temperature. However, it still has the following drawbacks:
1. Its temperature sensor should be scanned across the forehead to obtain plural temperature readings to thereby possibly contact the person (body) when measured in a public place to incur the infection danger if he is a virus carrier.
2. The probe of the thermometer should be carefully moved to search for the superficial temporal artery near the eyebrow in order to obtain a most reliable temperature data, thereby causing inconvenient measurement.
3. There is no focusing mechanism provided in the prior art so that the variation of measuring distance between the forehead and the sensor may influence its measurement precision.

The present inventor has found the drawbacks of the conventional thermometer and invented the present hygienic forehead thermometer without contacting the measured human body.

### SUMMARY OF THE INVENTION

The object of the present invention is to provide a forehead thermometer including: a main body having a probe formed on a front portion of the main body, a thermal-mass sleeve concentrically formed in a central hole of the probe, a Fresnel lens formed on a front end portion of the probe for focusing an incoming infrared temperature signal as emitted from the temperature sensing area on a patient's forehead to an infrared sensor secured to a bottom portion of the sleeve, an electronic circuit connected with the sensor and secured in the main body, and a lamp connected to the circuit and formed in the main body juxtapositioned to the sensor for projecting light forwardly to be parallel to a longitudinal axis of the Fresnel lens and the sensor for optically aiming a reference target area approximating the temperature sensing area for quickly locating the temperature sensing area for hygienically measuring a patient's temperature.

### BRIEF DESCRIPTION OF THE DRAWINGS

FIG. 1 is a partial sectional drawing of the present invention.

FIG. 2 is an illustration showing the measuring area on a patient's forehead in accordance with the present invention.

FIG. 3 is a circuit flow diagram of the present invention.

FIG. 4 is an illustration showing the transmission of IR temperature signal from the sensing area to be focused through the Fresnel lens of the present invention.

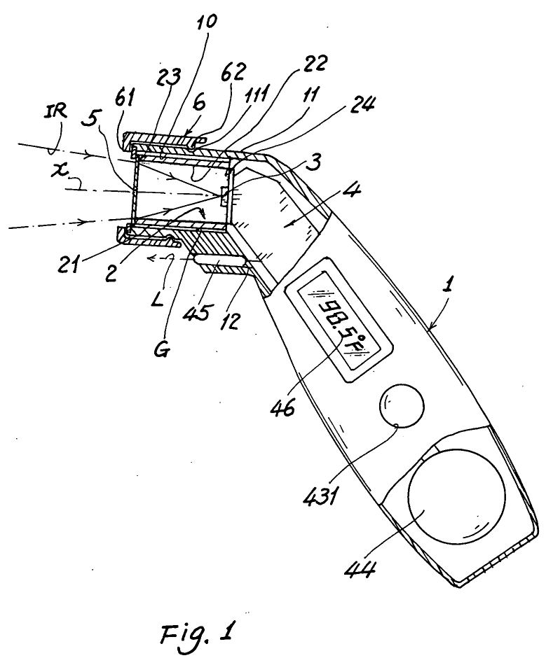

### DETAILED DESCRIPTION

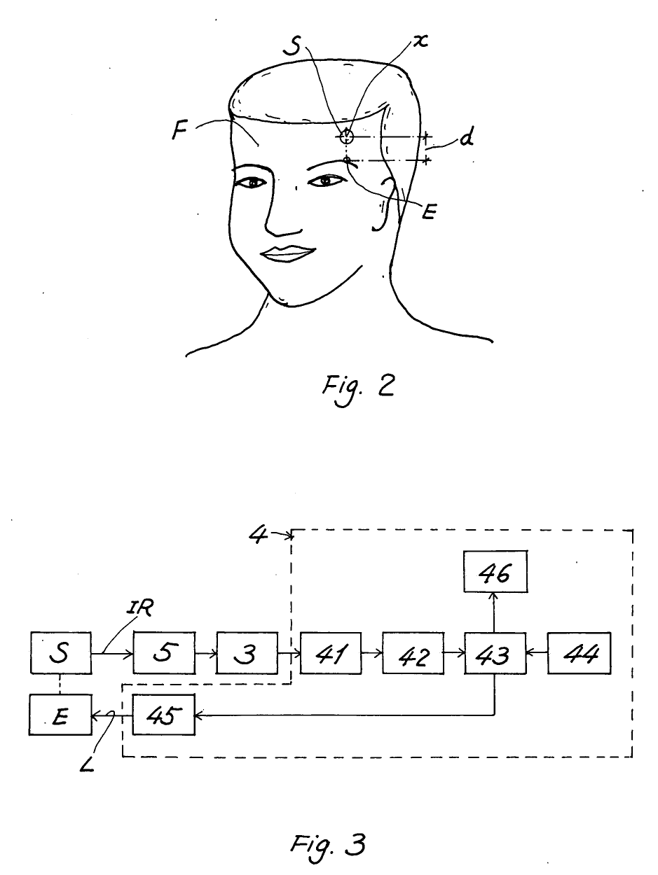

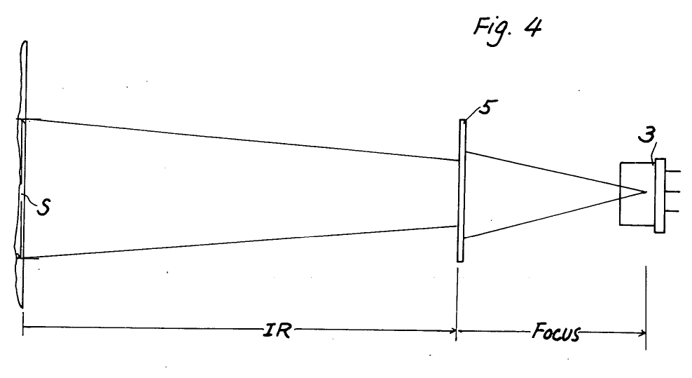

As shown in the drawing figures, the present invention comprises: a main body 1 having a probe 11 formed on a front or upper portion of the main body 1 and defining a central hole 10 in the probe 11; a thermal-mass sleeve 2 concentrically formed in the central hole 10 of the probe 11; an infrared sensor 3 secured to a bottom portion 24 of the sleeve 2; an electronic circuit 4 electrically connected with the sensor 3 and fixed in the main body 1; a Fresnel lens 5 secured on a front end portion 23 of the sleeve for guiding and focusing an infrared temperature signal IR, as emitted from a temperature sensing (or measuring) area S on a patient's forehead F near his (or her) eyebrow E (FIG. 2), on the sensor 3; and a disposable hygienic cap 6 covering the front portion of the probe 11.

Since the present invention discloses a non-contacting body thermometer, the hygienic cap 6 may also be eliminated in this invention.

The main body 1 including the probe 11 is made of thermally insulative materials. The cap 6 is also made of thermally insulating material and has a central opening 61 communicated with the central hole 10 of the probe 11, and a plurality of tenons 52 to be engaged with a groove 111 annularly recessed in the probe 11 for stably securing the cap 6 on the probe 11.

The thermal-mass sleeve 2 includes: a hollow cylinder 21 made of high thermal conductivity materials, and a central hole 22 formed through the hollow cylinder and recessed inwardly or rearwardly from the front end portion 23 of the sleeve 21 towards the bottom portion 24 of the sleeve; having the sensor 3 formed on the bottom portion 24.

The thermal-mass sleeve 2 is provided for forming isothermal status among the elements or components of the present invention for minimizing unexpected thermal background radiation for increasing the measurement reliability of the present invention. The central hole 22 in the sleeve 2 provides a path for inwardly passing the infrared temperature signal as radiated from the sensing surface S on the patient's forehead F.

The cylinder 21 of the sleeve 2 defines an air gap G between the cylinder 21 and the inside wall of the probe 11 for thermally insulating the ambient heat transferred into the sensor 3.

The electronic circuit 4 of the present invention includes: an amplifier 41 electrically connected to the sensor 3 for amplifying the infrared temperature signal IR as sensed by the sensor 3, a converter 42 connected to the amplifier 41 for converting an analog infrared temperature signal into a digital infrared temperature signal, a controller 43 connected to the converter 42 for receiving and processing the digital signal from the converter 42, a power source 44 which includes batteries stored in the main body 1 for powering the circuit 4, a lamp 45 electrically connected to the controller 43 and secured in a lamp socket 12 recessed in a front portion of the main body 1 and juxtapositioned to the probe 11 for projecting light L forwardly for optically aiming a reference target area (such as an eyebrow) E approximating the temperature sensing (or measuring) area S with a predetermined distance “d” (e.g. one inch between the eyebrow E and the sensing area S where the superficial temporal artery is located), and a display 46 connected to the controller 43 and formed on the main body 1 for showing a temperature data as measured by this invention.

The lamp 45 is juxtapositioned to the probe 11 and sleeve 2 to project a light L optically aiming at the reference target area E, with the light L being parallel to a longitudinal axis X formed through a longitudinal center of the Fresnel lens 5 and a center of the sensor 3. The axis X may be projectively aligned with a center of the temperature sensing area S, or may be generally perpendicular to the sensing area S.

The major elements of the electronic circuit 4 may be mounted on a printed circuit board fixed in the main body 1. The lamp 45 may be a LED or any other lamps, not limited in this invention.

For measuring a patient's forehead temperature, a switch 431 of the controller 43 is actuated to turn on the lamp 45 to project the aiming light L towards the reference target area E, and the infrared temperature signal IR as radiated from the temperature sensing area S will be transmitted into the probe 11 and focused, through the Fresnel lens 5, on the sensor 3 to be sensed on the sensor (FIG. 4). The infrared temperature signal IR will then be processed by the electronic circuit 4 to show a measured temperature data on the display 46 which is formed on a window on the main body 1.

The present invention is superior to the prior art (e.g., U.S. Pat. No. 6,292,685) with the following advantages:
1. Just optically aiming the light L on the reference target area, namely the eyebrow E, the sensing area S as separated from the reference target area E will be automatically obtained (as definitely separated from the reference light L by the distance “d”) for a quicker convenient forehead temperature measurement.
2. A Fresnel lens 5 is provided in front of the sensor 3 for focusing the radiation signal as remotely emitted from the sensing area so that the probe 11 is no longer contacted with a patient's body portion to prevent from any possible contamination or infection as spread from the patient. Therefore, it provides a non-contacting body thermometer to ensure a precise and absolute hygienic and healthy body temperature measurement.

Naturally, the present invention may also be provided for measuring the body temperature of any other locations, not limited in the present invention.

The lamp 45 may also be modified to be variably adjusted as separated from the axis X of the lens 5 and the sensor 3 for varying the distance “d” between the reference target area E and the temperature sensing area S.

The present invention may be modified without departing from the spirit and scope of the present invention.

I claim:

1. A forehead thermometer comprising:
a main body having a probe formed on a front portion of said main body;
a thermal-mass sleeve formed in said probe, having a Fresnel lens secured in a front end portion of said sleeve, and an infrared sensor formed in a bottom portion of said sleeve; and a longitudinal axis defined at a longitudinal center of said lens and said sensor to be generally perpendicular to a temperature sensing area on a patient's body portion;
a lamp formed in said main body and juxtapositioned to said longitudinal axis of said probe and said sleeve for projecting a light parallel to said axis to optically aim at a reference target area on the patient's body portion;
said reference target area separating from said axis of said center of said temperature sensing area with a predetermined distance;
whereby upon actuation of said electronic circuit to turn on said lamp to optically aim at said reference target area, said temperature sensing area will be automatically obtained; and an infrared temperature signal as radiated from the sensing area will be transmitted through said lens to be focused on said sensor and to be processed by said electronic circuit for obtaining a temperature data without contacting the patient's body portion.

2. A thermometer according to claim 1, wherein said thermal-mass sleeve includes: a hollow cylinder made of materials having high thermal conductivity, and a central hole formed through the hollow cylinder and recessed inwardly from the front end portion of the sleeve towards the bottom portion of the sleeve; said cylinder of the sleeve defining an air gap between the cylinder and an inside wall of the probe for thermally insulating ambient heat from being transferred into the sensor.

3. A thermometer according to claim 1, wherein said electronic circuit includes: an amplifier electrically connected to the sensor for amplifying the infrared temperature signal as sensed by the sensor, a converter connected to the amplifier for converting an analog infrared temperature signal into a digital infrared temperature signal, a controller connected to the converter for receiving and processing the digital infrared temperature signal from the converter, a power source formed in the main body for powering the electronic circuit, a lamp electrically connected to the controller and secured in a lamp socket recessed in a front portion of the main body and juxtapositioned to the probe for projecting light forwardly for optically aiming the reference target area approximating the temperature sensing area with the predetermined distance, and a display connected to the controller for showing the temperature data as measured.
